(19) United States
(12) Patent Application Publication
(10) Pub. No.: US 2026/0255252 A1
(43) Pub. Date: Aug. 27, 2026

(54) METHODS, DEVICES, AND MEDIUM FOR COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/994,426

(22) PCT Filed: Jul. 15, 2022
(86) PCT No.: PCT/CN2022/106120

§ 371 Date: Jan. 14, 2025

(51) Int. Cl. H04W 40/08

(52) U.S. Cl. CPC H04W 40/08

(57) ABSTRACT

Example embodiments of the present disclosure relate to methods, devices, and computer storage medium for communication. A network device determines a forwarding carrier of an NCR based on capability information of the NCR; transmits, to the NCR, an indication of the forwarding carrier; and transmits, to the NCR, a signal to be forwarded by the NCR to a terminal device on the forwarding carrier.

### FIELD

Example embodiments of the present disclosure generally relate to the field of communication techniques and in particular, to methods, devices, and a computer readable medium for communication.

### BACKGROUND

Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable.

A network-controlled repeater (NCR) is proposed to receive and process side control information from the network. Side control information could allow a network-controlled repeater to perform its amplify-and-forward operation in a more efficient manner. Potential benefits could include mitigation of unnecessary noise amplification, transmissions and receptions with better spatial directivity, and simplified network integration.

### SUMMARY

In general, example embodiments of the present disclosure provide methods, devices and a computer storage medium for communication.

In a first aspect, there is provided a method of communication. The method comprises: determining, at a network device, a forwarding carrier of a network controlled repeater (NCR) based on capability information of the NCR; transmitting, to the NCR, an indication of the forwarding carrier; and transmitting, to the NCR, a signal to be forwarded by the NCR to a terminal device on the forwarding carrier.

In a second aspect, there is provided a method of communication. The method comprises: receiving, at a network controlled repeater (NCR) from a network device, an indication of a forwarding carrier of the NCR, the forwarding carrier being associated with capability information of the NCR; receiving, from the network device, a signal on the forwarding carrier; and transmitting, to a terminal device, the signal on the forwarding carrier.

In a third aspect, there is provided a network device. The network device comprises a processor and a memory. The memory is coupled to the processor and stores instructions thereon. The instructions, when executed by the processor, cause the network device to perform the method according to the first aspect above.

In a fourth aspect, there is provided a network-controlled repeater. The network-controlled repeater comprises a processor and a memory. The memory is coupled to the processor and stores instructions thereon. The instructions, when executed by the processor, cause the network-controlled repeater to perform the method according to the second aspect above.

In a fifth aspect, there is provided a computer readable medium having instructions stored thereon, the instructions, when executed on at least one processor, causing the at least one processor to carry out the method according to any of the first to the sixth aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates an example scenario of the communication system as shown in FIG. 1;

FIG. 3A illustrates a definition of channel bandwidth and transmission bandwidth configuration for one NR channel in which some embodiments of the present disclosure may be implemented;

FIG. 3B illustrates an example relationship between bandwidths in which some embodiments of the present disclosure may be implemented;

FIG. 4 illustrates a signalling chart illustrating communication process in accordance with some embodiments of the present disclosure;

FIG. 5A illustrates an example consecutive carrier for NCR-Fwd in accordance with some embodiments of the present disclosure;

FIG. 5B illustrates an example non-consecutive carrier for NCR-Fwd in accordance with some embodiments of the present disclosure;

FIG. 5C illustrates example carriers for NCR-Fwd in accordance with some embodiments of the present disclosure;

FIG. 6A illustrates an example relationship between the activated bandwidth for NCR-MT and the indicated forwarding bandwidth in accordance with some embodiments of the present disclosure;

FIG. 6B illustrates carrier-level ON-OFF information in accordance with some embodiments of the present disclosure;

FIG. 7 illustrates a signalling chart illustrating communication process in accordance with some embodiments of the present disclosure;

FIG. 8 illustrates a flowchart of an example method in accordance with some embodiments of the present disclosure

FIG. 9 illustrates a flowchart of an example method in accordance with some embodiments of the present disclosure; and

FIG. 10 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Mobile operators rely on different types of network nodes to offer blanket coverage. As a result, new types of network nodes have been considered to increase mobile operators' flexibility for their network deployments. For example, Integrated Access and Backhaul (IAB) was introduced in Rel-16 and enhanced in Rel-17 as a new type of network node not requiring a wired backhaul. Another type of network node is the radio frequency (RF) repeater which simply amplify-and-forward any signal that they receive. RF repeaters have seen a wide range of deployments in 2G, 3G and 4G to supplement the coverage provided by regular full-stack cells. In Rel-17, radio access network 4 (RAN4) specified RF and electromagnetic compatibility (EMC) requirements for such RF repeaters for NR targeting both FR1 and FR2.

While an RF repeater presents a cost effective means of extending network coverage, it has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc.

A network-controlled repeater is an enhancement over conventional RF repeaters with the capability to receive and process side control information from the network. Network-controlled repeater is introduced by adding side control information for beam management based on RF repeater, to extend the coverage in high frequency (HF) with a higher efficient method.

Side control information is necessary for NCRs including assumption of max transmission power. In some examples, the side control information may indicate at least one of: beamforming information, timing information to align transmission/reception boundaries of network-controlled repeater, information on uplink (UL)-downlink (DL) time division duplex (TDD) configuration, ON-OFF information for efficient interference management and improved energy efficiency, or power control information for efficient interference management.

In some embodiments, network-controlled repeaters are inband RF repeaters used for extension of network coverage of FR1 and FR2. However, how to utilize the transmission bandwidth of the network-controlled repeater efficiently is still needed to be studied.

Embodiments of the present disclosure provide a solution of communication. In the solution, a network device may obtain capability information related to forwarding carrier of the NCR, and the network device may transmit an indication of a forwarding carrier to be used. As such, the forwarding carrier used for forwarding data may be reduced and the transmission performance may be improved. Principles and implementations of the present disclosure will be described in detail below with reference to the figures.

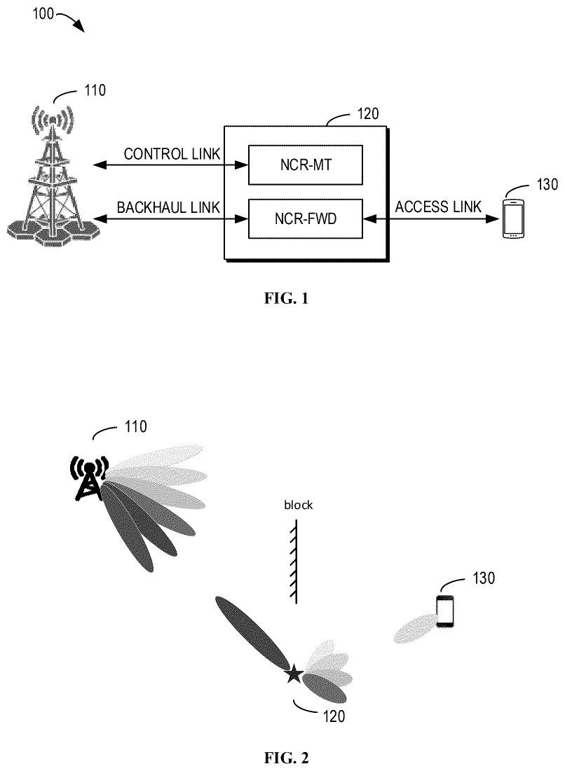

FIG. 1 illustrates an example communication system 100 in which some embodiments of the present disclosure can be implemented. The communication system 100, which is a part of a communication network, includes a network device 110, a network-controlled repeater 120, and a terminal device 130.

The network device 110 can provide services to the terminal device 130, and the network device 110 and the terminal device 130 may communicate data and control information with each other. In some embodiments, the network device 110 and the terminal device 130 may communicate via the network-controlled repeater 120.

The network-controlled repeater 120 includes a function of network-controlled repeater-mobile termination (NCR-MT) and a function of network-controlled repeater-forwarding (NCR-Fwd), for example, the network-controlled repeater is defined in TR 38.867.

The NCR-MT is defined as a function entity to communication with the network device 110 via a control link (C-link) to enable the information exchanges. In some examples, the C-link is based on NR-Uu interface. The information transmitted via the C-link may include side control information. In some examples, the side control information may be used for the control of NCR-Fwd.

The NCR-Fwd is defined as a function entity to perform the amplify-and-forwarding of UL/DL RF signal between the network device 110 and the terminal device 130 via a backhaul link and an access link. The behavior of the NCR-Fwd may be controlled according to the received side control information from the network device 110.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

In some embodiments, for the network-controlled repeater 120, a carrier/cell/BWP is necessary to communicate with the network device 110, i.e., to receive side control information. In some embodiments, for the network-controlled repeater 120, a frequency band with a certain bandwidth and a certain central frequency is enough to forward a signal. In some examples, the central frequency and the bandwidth of the frequency band for forwarding can be configured by an operation administration and maintenance (OAM) or stored in the network-controlled repeater 120 before leaving factory.

In some embodiments, at least one of the NCR-MT's carrier(s) should be within the set of carriers forwarded by the NCR-Fwd in a same frequency range, and the NCR-MT and NCR-Fwd may be operating in the same carrier.

However, a fixed forwarding bandwidth should be large enough to support flexible carrier chosen of scheduling in gNB, leading to an unavoidable interference when the bandwidth of the incident signal of NCR or the received signal to be forwarded by NCR is less than the forwarding bandwidth.

FIG. 2 shows an example scenario of the communication system 100 as shown in FIG. 1. In the specific example of FIG. 2, the direct link between the network device 110 and the terminal device 130 is blocked, and the network-controlled repeater 120 is used for forwarding signal(s) between the network device 110 and the terminal device 130.

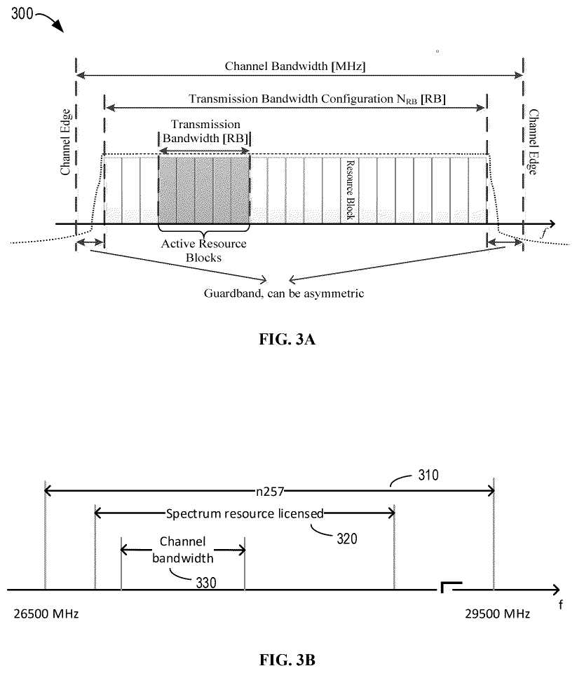

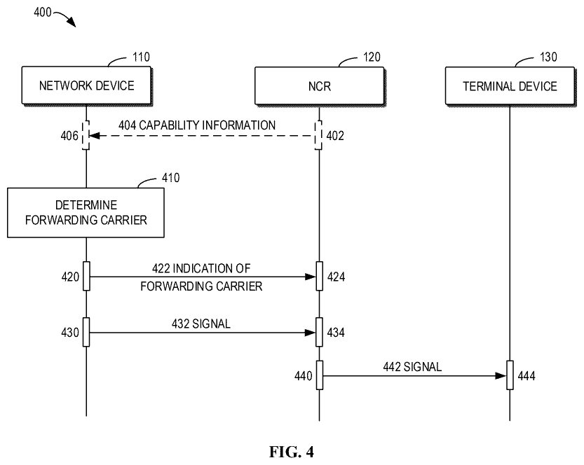

The 3GPP specification 38.104 has defined a BS channel bandwidth for a network device 110 (such as a base station). FIG. 3A shows a definition of channel bandwidth and transmission bandwidth configuration for one NR channel 300 in which some embodiments of the present disclosure may be implemented. The BS channel bandwidth supports a single NR RF carrier in the uplink or downlink at the Base Station. Different UE channel bandwidths may be supported within the same spectrum for transmitting to and receiving from UEs connected to the BS. The placement of the UE channel bandwidth is flexible but can only be completely within the BS channel bandwidth. The BS shall be able to transmit to and/or receive from one or more UE bandwidth parts that are smaller than or equal to the number of carrier resource blocks on the RF carrier, in any part of the carrier resource blocks. As shown in FIG. 3A, a relationship between the channel bandwidth, the guardband and the transmission bandwidth configuration is illustrated.

Additionally, the transmission bandwidth configuration N_{RB} for each BS channel bandwidth and subcarrier spacing (SCS) is shown below in Table 1 and Table 2.

TABLE 1
Transmission bandwidth configuration N_{RB} for FR1

| | 5 | 10 | 15 | 20 | 25 | 30 | 40 | 50 | 60 | 70 | 80 | 90 | 100 |
|---|---|---|---|---|---|---|---|---|---|---|---|---|---|
| SCS | MHz | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A | N/A |
| 30 | 11 | 24 | 38 | 51 | 65 | 78 | 106 | 133 | 162 | 189 | 217 | 245 | 273 |
| 60 | N/A | 11 | 18 | 24 | 31 | 38 | 51 | 65 | 79 | 93 | 107 | 121 | 135 |

TABLE 2
Transmission bandwidth configuration N_{RB} for FR2

| SCS | 50 MHz | 100 MHz | 200 MHz | 400 MHz |
|---|---|---|---|---|
| (kHz) | N_{RB} | N_{RB} | N_{RB} | N_{RB} |
| 60 | 66 | 132 | 264 | N/A |
| 120 | 32 | 66 | 132 | 264 |

In some embodiments, the global frequency raster defines a set of RF reference frequencies F_{REF}. The RF reference frequency is used in signalling to identify the position of RF channels, SS blocks and other elements. The global frequency raster is defined for all frequencies from 0 to 100 GHz. The granularity of the global frequency raster is ΔF_{Global}.

RF reference frequencies are designated by an NR Absolute Radio Frequency Channel Number (NR-ARFCN) in the range [0 . . . 3279165] on the global frequency raster. The relation between the NR-ARFCN and the RF reference frequency F_{REF} in MHz is given by the following equation (1), where F_{REF-Offs} and N_{Ref-Offs} are given in Table 3 below and N_{REF} is the NR-ARFCN.

$${F}_{REF} = {F}_{REF - Offs} + Δ {F}_{Global} ( {N}_{REF} - {N}_{REF - Offs} ) \qquad ( 1 )$$

TABLE 3
NR-ARFCN parameters for the global frequency raster

| Range of | ΔF_{Global} | F_{REF-Offs} | | |
|---|---|---|---|---|
| frequencies (MHz) | (kHz) | (MHz) | N_{REF-Offs} | Range of N_{REF} |
| 0-3000 | 5 | 0 | 0 | 0-599999 |
| 3000-24250 | 15 | 3000 | 600000 | 600000-2016666 |

In the context of the present disclosure, the term “operation band” may refer to a bandwidth in which a NR is designed to operate. In some examples, the operation band may be those defined as tables 5.2-1 of FR1 and 5.2-2 of FR2 in TS 38.104 for NR operating. For example, Table 4 below shows several NR operating bands in FR2.

TABLE 4
NR operating bands in FR2

| | Uplink (UL) and Downlink (DL) operating band | |
|---|---|---|
| | BS transmit/receive | |
| NR | UE transmit/receive | |
| operating | F_{UL, low}-F_{UL, high} | Duplex |
| band | F_{DL, low}-F_{DL, high} | mode |
| n257 | 26500 MHz-29500 MHz | TDD |
| n258 | 24250 MHz-27500 MHz | TDD |
| n259 | 39500 MHz-43500 MHz | TDD |
| n260 | 37000 MHz-40000 MHz | TDD |
| n261 | 27500 MHz-28350 MHz | TDD |

In the context of the present disclosure, the term “channel bandwidth” may be a bandwidth within the operating band. In some examples, the channel bandwidth may be a carrier of signal from the network device 110. In some examples, a maximum number of RBs is defined per carrier bandwidth and SCS, for example, the maximum number of RBs may be 275. In some examples, two guard bands may be defined at two edges of the channel bandwidth respectively, where the two guard bands may be symmetric or asymmetric.

In the context of the present disclosure, a spectrum resource of a given network device (such as a gNB) may be determined based on its operator. In some embodiments, different spectrum resources within the operating band may be licensed for different operators. Table 5 shows example spectrum resources for different operators.

TABLE 5
spectrum resources for different operators

| | 5G bands | Bandwidth | Operating |
|---|---|---|---|
| Operator | (MHz) | (MHz) | band index |
| China Mobile | 2515~2675 | 160 | n41 |
| | 4800~4900 | 100 | n79 |
| China Telecom | 3400~3500 | 100 | n78 |
| China Unicom | 3500~3600 | 100 | n78 |

FIG. 3B shows an example relationship between bandwidths in which some embodiments of the present disclosure may be implemented. The operating band 310 shown in FIG. 3B is n257 (26500 MHz-29500 MHz), the spectrum resource licensed 320 is within (or part of) the operating band 310, and the channel bandwidth 330 is within (or part of) the operating band 310.

In some example embodiments, a working bandwidth of the network-controlled repeater 120 may be the same with the spectrum resource of the network device 110 (such as gNB) related to the network-controlled repeater 120. In some example embodiments, the working bandwidth of the network-controlled repeater 120 may include a NCR-MT bandwidth and a NCR-Fwd bandwidth. In some examples, the NCR-MT bandwidth may refer to a bandwidth carrying the interacted information between the network device 110 and the network-controlled repeater 120. In some examples, the NCR-Fwd bandwidth may refer to a bandwidth only within which the signal can be received and/or forwarded.

In the present disclosure, some terms may refer to a same or similar physical meaning and may be used interchangeably. For example, the term “carrier” may refer to a certain frequency bandwidth with a certain central frequency, it may be used interchangeably with “sub-channel”, and “frequency resource”. For example, the term “bandwidth” may refer to a size of a carrier in frequency domain. For example, the terms

“NCR-MT”, “MT”, “a function of MT”, “a function of NCR-MT”, and “MT function” may be used interchangeably. For example, the terms “NCR-Fwd”, “Fwd”, “a function of forwarding”, “a function of NCR forwarding”, “a function of NCR-Fwd”, and “Fwd function” may be used interchangeably.

Reference is first made to FIG. 4, which illustrates a signalling chart illustrating communication process 400 in accordance with some example embodiments of the present disclosure. Only for the purpose of discussion, the process 400 will be described with reference to FIG. 1. The process 400 may involve the network device 110, the network-controlled repeater (NCR) 120, and the terminal device 130.

The network device 110 determines 410 a forwarding carrier of the NCR 120 based on capability information of the NCR 120. In some example embodiments, the network device 110 may obtain or determine the capability information of the NCR 120. In some example embodiments, the capability information of the NCR 120 may indicate forwarding capability information of the NCR 120, that is, capability information of NCR-Fwd.

In some example embodiments, the capability information of the NCR 120 may be hard coded at the network device 110, or the capability information of the NCR 120 may be configured by OAM. In some examples, the network device 110 may receive the capability information of the NCR 120 from the OAM. For example, if the NCR 120 is stable, the coverage hole addressed by it is stable too, in this case, the capability information of the NCR 120 may be set as a property.

In some example embodiments, alternatively or in addition, as shown in FIG. 4, the NCR 120 may transmit 402 the capability information 404 of the NCR 120 to the network device 110. And accordingly, the network device 110 may receive 406 the capability information 404.

In some examples, if a connection between the NCR 120 and the network device 110 is established through an initial access procedure, the NCR 120 may report its capability information 404 as a normal terminal device. In some embodiments, the capability information 404 may be reported through RRC signaling. In some embodiments, the capability information 404 may include two sets, one set for NCR-MT and the other set for NCR-Fwd. In some examples, a set of capability information for NCR-MT may be a BWP reporting as a normal terminal device and the present disclosure will not described in detail. In some examples, a set of capability information for NCR-Fwd may be a dedicated reporting.

In some embodiments, the forwarding carrier may be determined based on the capability information of the NCR, and the capability information of the NCR may comprise the capability information for NCR-Fwd. In some examples, the forwarding carrier may have a forwarding bandwidth, such as 100 MHz or another value.

In some embodiments, the capability information may indicate a capability type related to the forwarding carrier of the NCR (or NCR forwarding carrier for short). For example, the capability type may be a dynamic type, a switch type, or a fixed type. In some embodiments, the capability information may further indicate a supported carrier of NCR-Fwd, where the supported carrier has a supported bandwidth of the NCR-Fwd.

In some example embodiments, the capability information may indicate that the capability type is the dynamic type, and the capability information may further indicate one or more of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth, where the adjusted bandwidth means the bandwidth between the adjusted starting point and the adjusted ending point.

In some examples, the number of carriers may be 1, as such, the supported carrier of the NCR-Fwd may be represented as a consecutive carrier. In some embodiments, the capability information may indicate a starting point and an ending point of the supported carrier. As such, the supported bandwidth may be determined based on the frequency resource between the starting point and the ending point of the supported carrier. In some embodiments, the capability information may indicate the supported bandwidth and the starting point (or the ending point).

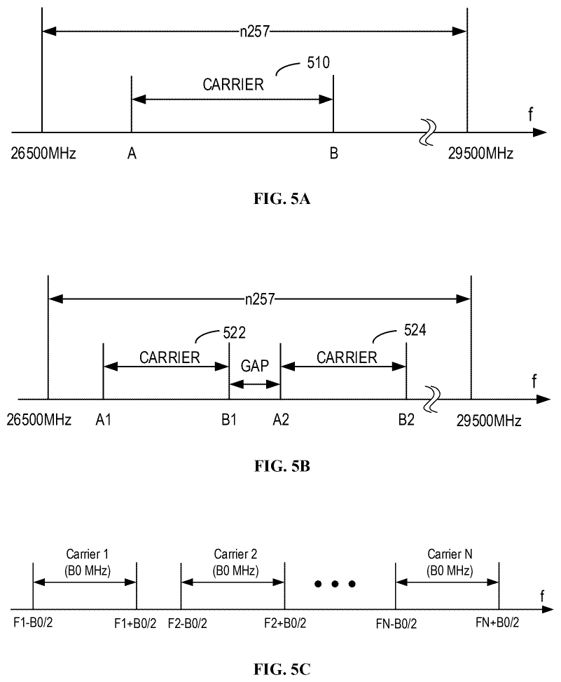

In some embodiments, the forwarding bandwidth may be dynamic adjusted within the supported bandwidth. In some examples, based on the dynamic type, the capability information may further indicate one of the three adjusted types: (1) both the starting point and the ending point of the forwarding carrier may be adjusted within the supported carrier having the supported bandwidth, (2) the starting point of the forwarding bandwidth is fixed and the ending point of the forwarding bandwidth may be adjusted, or (3) the starting point of the forwarding bandwidth may be adjusted and the ending point of the forwarding bandwidth is fixed. In some examples, the capability information may indicate a first step for adjusting the starting point and a second step for adjusting the ending point. The first step and the second step may be the same or may be different. In some examples, the minimum or maximum forwarding bandwidth may be indicated too. It is understood that the maximum forwarding bandwidth should be less than the supported bandwidth. A detailed embodiment of the one consecutive carrier will show below with reference to FIG. 5A.

In some examples, the number of carriers may be greater than 1, as such, the supported carrier of the NCR-Fwd may be represented as multiple consecutive carriers (or a non-consecutive carrier as a whole). In some examples, there may be a gap between two adjacent consecutive carriers. In some examples, the multiple consecutive carriers may also be called as multiple sub-channels, multiple sub-carriers or the like, the present disclosure does not limit this aspect.

In some embodiments, the capability information may indicate multiple starting points and multiple ending points of the supported multiple consecutive carriers. For example, there may be a list of starting points and a list of ending points. For example, each of the multiple consecutive carriers has a same bandwidth; in this case, the capability information may indicate multiple starting points or multiple ending points and the common bandwidth.

For each of the multiple consecutive carriers, the capability information may indicate one or more of: whether the starting point of the forwarding carrier is adjusted within the corresponding consecutive carrier, whether the ending point of the forwarding carrier is adjusted within the corresponding consecutive carrier, a first step for adjusting the starting point, a second step for adjusting the ending point, a minimum value of the adjusted bandwidth, or a maximum value of the adjusted bandwidth. A detailed embodiment of the multiple consecutive carriers will show below with reference to FIG. 5B.

In some example embodiments, the capability information may indicate that the capability type is the switch type, and the capability information may further indicate one or more of: multiple indexes of multiple carriers in a set of pre-determined carriers, multiple bandwidths for the multiple carriers, a maximum number of carriers being used for forwarding simultaneously, or an index of a subset of carriers being used for forwarding simultaneously.

In some embodiments, there may be a set of pre-determined carriers, and a predefined relationship between a set of indexes and the set of pre-determined carriers may be defined. In some examples, the capability information may indicate multiple indexes from the set of indexes. As such, the supported carriers may be determined based on the multiple indexes. In some embodiments, the switch type may represent that the forwarding carrier may be switch among the multiple carriers.

In some examples, each carrier in the set of pre-determined carriers may be with a same bandwidth. For example, the same bandwidth may be B0 MHz. In some other examples, the bandwidths of different carriers may be different. In some examples, multiple bandwidths associated with the multiple indexes may be further indicated.

In some examples, the set of carriers may be represented as an NR-ARFCN associated with a central frequency of a corresponding carrier. For example, each of the set of carriers may be represented as N_{REF}, as shown in equation (1) and Table 3 described above. In some examples, the central frequency of a corresponding carrier may be the RF reference frequency of the NR-ARFCN. As such, the indication of the carriers may be simplified. A detailed embodiment of the multiple carriers will show below with reference to FIG. 5C.

In some embodiments, there may be multiple subset of carriers, each subset includes one or more carriers. In some examples, a predefined relationship between multiple subset indexes and the multiple subset of carriers may be defined. In some examples, the capability information may indicate one or more subset indexes from the multiple subset indexes. As such, the supported carriers may be determined based on the one or more subset indexes.

In some embodiments, each carrier may be with a same bandwidth, such as B0 MHz. In some examples, each carrier may be represented as its central frequency. Table 6 shows an example of the multiple subset of carriers. In some examples, the subset index may be represented as “CG” and the present disclosure does not limit this aspect. As shown in Table 6, each of f1, f2 and f3 may represent a central frequency of corresponding carrier as pre-defined. For examples, a subset of carriers with an index 4 includes two carriers, one of the two carriers has a central frequency f1 and the other of the two carriers has a central frequency f2.

TABLE 6
multiple subset of carriers

| Subset index (CG) | Combination of carriers |
|---|---|
| 1 | {f1} |
| 2 | {f2} |
| 3 | {f3} |
| 4 | {f1, f2} |
| 5 | {f2, f3} |
| . . . | . . . |

In some examples, the capability information may further indicate a maximum number of carriers being used for forwarding simultaneously. For example, the maximum number of carriers being used for forwarding simultaneously may be 4 or 8. In some examples, in case the maximum number of carriers being used for forwarding simultaneously is not indicated, it may be determined as a default value, such as 1.

In some examples, the maximum number of carriers being used for forwarding simultaneously may be implicated indicated by a subset index. For example, if a specific field (indicates the maximum number of carriers being used for forwarding simultaneously) in the capability information indicates a subset index 5, the maximum number of carriers being used for forwarding simultaneously may be determined as 2 based on Table 6, since there are two carries in the subset of carriers with the subset index 5.

In some example embodiments, the capability information may indicate that the capability type is the fixed type, and the capability information may further indicate the supported carrier with a fixed bandwidth for the NCR-Fwd.

In some example embodiments, the network device 110 may determine the forwarding carrier of NCR based on the capability information and an activated carrier for NCR-MT. In some examples, the network device 110 may activate a carrier for NCR-MT, and then determine the forwarding carrier. In some examples, the activated carrier for NCR-MT has an activated bandwidth, and the forwarding carrier has a forwarding bandwidth.

In some embodiments, if the capability information indicates a minimum value of the bandwidth, the determined forwarding bandwidth should be greater than the minimum value. In some embodiments, if the capability information indicates a maximum value of the bandwidth, the determined forwarding bandwidth should be less than the maximum value. In some embodiments, if the capability information indicates a maximum number of carriers being used for forwarding simultaneously, the determined forwarding bandwidth may include multiple carriers less than the maximum number of carriers being used for forwarding simultaneously.

In some embodiments, the activated bandwidth for NCR-MT may be within the forwarding bandwidth, in other words, the forwarding bandwidth may be larger than the activated bandwidth for NCR-MT. In some embodiments, the network device 110 may inform the NCR 120 the activated bandwidth for NCR-MT. For example, the activated bandwidth for NCR-MT (the frequency domain resource of NCR-MT) may be indicated by a semi-static method and the present disclosure does not limit this aspect.

Continuing with reference to FIG. 4, the network device 110 transmits 420 an indication of the forwarding carrier 422 to the NCR 120. In some embodiments, the indication may be carried in side control information. In some embodiments, the indication may be transmitted via the control link between the network device 110 and the NCR 120.

In some embodiments, the indication may be carried in a field of DCI. In some embodiments, the field may be a newly-defined field, such as a reserved one. In some embodiments, the field may be an existing field which is reused or redefined for the indication. For example, the field may be corresponding to a modulation and coding scheme (MCS), a transmission configuration indicator (TCI), or a frequency domain resource allocation (FDRA). In some embodiments, the indication may be carried in a field of MAC CE or RRC. In some examples, the channel condition between the network device 110 and the NCR 120 is stable than that between the network device 110 and a normal terminal device. As such, the MCS, the TCI or the FDRA may be carried in an MAC CE or RRC, which may be transmitted in a semi-static method. As such, there is no need to carry the MCS, the TCI or the FDRA in DCI, and the corresponding filed in DCI can be reused to indicate the forwarding carrier of NCR.

In some embodiments, if the capability information indicates that the capability type is the dynamic type or the switch type, the indication may be transmitted. In some embodiments, the indication may be used for indicate the forwarding carrier directly/explicitly, implicitly or hybrid.

In some example embodiments, if the capability information indicates that the capability type is the dynamic type, the indication may indicate the forwarding carrier directly/explicitly.

In some examples, the indication may indicate a starting point and an ending point of the forwarding carrier. In some examples, if the starting point of the forwarding bandwidth cannot be adjusted, only the adjusted ending point is indicated. In some examples, if the ending point of the forwarding bandwidth cannot be adjusted, only the adjusted starting point is indicated.

In some examples, the indication may indicate the starting point and a value of the forwarding bandwidth. In some examples, the indication may indicate the ending point and a value of the forwarding bandwidth. In some examples, the value of the forwarding bandwidth may be indicated by two bits. For example, bits “00” represent 100 MHz, bits “01” represent 200 MHz, bits “10” represent 400 MHz, and bits “11” are reserved.

In some examples, the indication may indicate a list of starting points and a list of ending points of the forwarding carrier. In some examples, the indication may indicate a list of indexes of carries corresponds to the forwarding carrier. In some examples, the list of indexes may be implemented by a list of NR-ARFCNs.

In some examples, the indication may indicate a list of indexes (for example, implemented by a list of NR-ARFCNs) and a list of bandwidths. For example, each in the list of bandwidths may be indicated by 2 bits. For example, bits “00” represent 100 MHz, bits “01” represent 200 MHz, bits “10” represent 400 MHz, and bits “11” are reserved.

In some examples, the indication may indicate a list of indexes (for example, implemented by a list of NR-ARFCNs) and a common bandwidth. In this case, each of the bandwidths corresponding to the list of indexes is the common bandwidth. As such, the indication manner may be simplified.

In some examples, the indication may indicate a list of central frequencies and a list of bandwidths. In some examples, the indication may indicate a list of central frequencies and a common bandwidth.

In some example embodiments, if the capability information indicates that the capability type is the dynamic type, the indication may indicate the forwarding carrier implicitly and explicitly (i.e., hybrid).

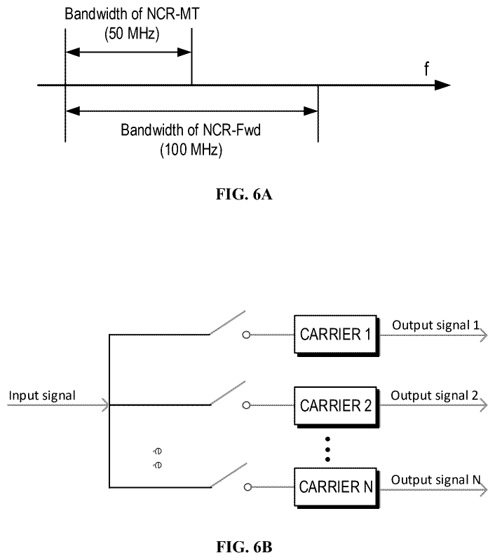

In some examples, the activated bandwidth for NCR-MT may be part of the forwarding bandwidth. In some examples, the indication may indicate a location of the activated bandwidth for NCR-MT within the forwarding bandwidth, and a scaling factor indicating a multiple of the forwarding bandwidth relative to the activated bandwidth for NCR-MT. In some examples, the location may be indicated by two bits For example, bits “00” represent the location is front, bits “01” represent the location is middle, bits “10” represent the location is end, and bits “11” are reserved. In some examples, the location of the activated bandwidth for NCR-MT within the forwarding bandwidth is pre-defined or pre-configured, and the indication may indicate a scaling factor indicating a multiple of the forwarding bandwidth relative to the activated bandwidth for NCR-MT. An example embodiment will show below with reference to FIG. 6A.

In some example embodiments, if the capability information indicates that the capability type is the switch type, the indication may indicate the forwarding carrier directly/explicitly.

In some examples, the indication may indicate one or more carriers from the supported carriers. In some embodiments, the indication may include one or more indexes of the one or more carriers. In some examples, the one of more indexes may be based on the indexes of a set of pre-determined carriers, where the supported carriers are within the set of pre-determined carriers. For example, there is a predefined relationship between the indexes and the set of pre-determined carriers. In some examples, the one of more indexes may be based on renumbered indexes of the supported carriers. For example, there may be N supported carriers, the renumbered indexes may be 1 to N or 0 to N-1, regardless of the predefined relationship between the indexes and the set of pre-determined carriers, where N is an integer.

In some examples, the indication may indicate at least one subset carrier of the supported subset of carriers, where the at least one subset carrier corresponds to the forwarding carrier. For example, the indication may include a subset index 4 to indicate the forwarding carrier includes two carriers with the central frequencies f1 and f2, based on Table 6 shown above. Alternatively, the indication may include a subset index 1 and a subset index 2 to indicate the same forwarding bandwidth. It is to be understood that the bandwidth and the RF frequency value associated with each central frequency is predefined.

In some example embodiments, if the capability information indicates that the capability type is the switch type, the indication may indicate the forwarding carrier implicitly and explicitly (i.e., hybrid).

In some embodiments, the indication may indicate a subset of carriers, for example, the indication may include an index of the subset of carriers. In some examples, the index may be the subset index of the subset of carriers, explicitly indication as described above. In some examples, the index may be renumbered or reordered so as to indicate the subset of carriers implicitly.

TABLE 7
multiple subset of carriers

| Subset index (CG) | Combination of carriers |
|---|---|
| 1 | {f1, f2} |
| 2 | {f2, f3} |
| 3 | {f3, f4} |
| 4 | {f2, f4} |
| 5 | {f1, f2, f3} |
| 6 | {f1, f2, f4} |
| 7 | {f2, f3, f4} |

In some examples, the index may be determined based on an order of determined subsets of carriers comprising the activated carrier for NCR-MT. It is assumed that the multiple subsets of carriers are shown in Table 7, where each of f1-f4 represents a central frequency of corresponding carrier. It is assumed that the activated carrier for NCR-MT has a central frequency f3 or located within carrier related to f3. As shown in Table 7, there are 7 subsets of carriers with subset indexes 1-7.

The subset carriers including the activated carrier for NCR-MT may be determined, such as the subsets with the subset indexes 2, 3, 5 and 7. The determined subsets may be further ordered and re-indexed. With reference to Table 8, the index may be any of 1-4 (option 1) or 0-3 (option 2). In some examples, the indication may include an index 3 (option 1) to indicate the third subset of carriers {f1, f2, f3}. In some examples, the indication may include an index 2 (option 2) to indicate the third subset of carriers {f1, f2, f3}.

As such, the subsets of carriers including the activated carrier for NCR-MT may be considered, regardless the location of the activated carrier for NCR-MT in the subsets.

TABLE 8

| | | Subset | |
|---|---|---|---|
| Re-Index | Re-Index | index | Combination |
| (option 1) | (option 2) | (CG) | of carriers |
| 1 | 0 | 2 | {f2, f3} |
| 2 | 1 | 3 | {f3, f4} |
| 3 | 2 | 5 | {f1, f2, f3} |
| 4 | 3 | 7 | {f2, f3, f4} |

In some examples, the index may be determined based on an order of determined subsets of carriers comprising the activated carrier for NCR-MT located at the front of each of the subsets of carriers.

The subset carriers including the activated carrier for NCR-MT at the front may be determined, such as the subset with the subset index 3. The determined subset(s) may be further ordered and re-indexed. With reference to Table 9, the index may be 1 (option 1) or 0 (option 2). In some examples, the indication may include an index 1 (option 1) or 0 (option 2) to indicate the first subset of carriers {f3, f4}. In some examples, in case of only one subset is re-indexed, the indication can be omitted due to the NCR can find the unique subset of carriers based on the activated carrier of NCR-MT.

TABLE 9
located at the front

| Re-Index | Re-Index | Subset | Combination |
|---|---|---|---|
| (option 1) | (option 2) | index (CG) | of carriers |
| 1 | 0 | 3 | {f3, f4} |

In some examples, the index may be determined based on an order of determined subsets of carriers comprising the activated carrier for NCR-MT located at the end of each of the subsets of carriers.

The subset carriers including the activated carrier for NCR-MT at the end may be determined, such as the subsets with the subset indexes 2 and 5. The determined subsets may be further ordered and re-indexed. With reference to Table 10, the index may be any of 1-2 (option 1) or 0-1 (option 2). In some examples, the indication may include an index 2 (option 1) or 1 (option 2) to indicate the second subset of carriers {f1, f2, f3}.

TABLE 10
located at the end

| Re-Index | Re-Index | Subset | Combination |
|---|---|---|---|
| (option 1) | (option 2) | index (CG) | of carriers |
| 1 | 0 | 2 | {f2, f3} |
| 2 | 1 | 5 | {f1, f2, f3} |

Based on the description with reference to Tables 7-10, the implicit (or hybrid) indication may be implemented. In some embodiments, if only one subset is determined, Table 9 for example, the indication may be omitted, as such, the signaling overhead may be reduced.

In some example embodiments, if the capability information indicates that the capability type is the switch type, the indication may indicate multiple states of the multiple carriers. For example, the multiple states may be multiple on-off states. As such, the indication may be carrier-level ON-OFF information. An example embodiment will show below with reference to FIG. 6B.

On the other side of communication, the NCR 120 receives 424 the indication of the forwarding carrier 422. And accordingly, the NCR 120 may determine the forwarding carrier based on the indication 422. It is understood that the indicated forwarding carrier is part of the supported forwarding carrier indicated by the capability information, and the indicated forwarding bandwidth is larger than the activated bandwidth for NCR-MT.

In some embodiments, the NCR 120 may turn on the indicated forwarding carrier and as such the power consumption may be reduced at the NCR 120.

Continuing with reference to FIG. 4, the network device 110 transmits 430 a signal 432 to the NCR 120, and the NCR 120 receives 434 the signal 432 accordingly. Additionally, the NCR 120 transmits 440 the signal 442 on the indicated forwarding carrier to the terminal device 130, and the terminal device 130 may receive 444 the signal 442.

Based on the embodiments with reference to FIG. 4, the forwarding carrier may be indicated by the network device 110, and the NCR 120 may only forward the signal on the indicated forwarding carrier. As such, there is no need to forward the signal on all the supported forwarding carrier, thus the interference may be reduced and the power consumption may be reduced.

In some example embodiments, the NCR 120 may provide a measurement result associated with predefined carriers. In some examples, the predefined carriers may also be called as predefined sub-carriers, multiple predefined carriers, multiple predefined sub-carriers, multiple subcarriers or the like, the present disclosure does not limit this aspect. In some examples, a consecutive carrier may be divided into the multiple sub-carriers. In some examples, the multiple sub-carriers may be multiple consecutive carriers in a non-consecutive carrier. In some examples, the multiple sub-carriers may be multiple carriers.

In some embodiments, the NCR 120 may determine a measurement result based on a configured reference signal (RS) or a sensor related to detect or sense a power of a received signal. The NCR 120 may further transmit the measurement result to the network device 110.

In some examples, the NCR-Fwd is capable of sensing powers of received signals on multiple predefined carriers. The power of a received signal may be a received signal receiving power (RSRP). In some examples, the NCR-Fwd is capable of sensing strength of received signals on multiple predefined carriers, which is denoted by a strength indicator of received signals. The strength indicator of a received signal may be a received signal strength indicator (RSSI). In some examples, the NCR-Fwd may determine sensing results associated with multiple predefined carriers, where the sensing results may include the RSRPs and/or RSSIs.

In some examples, the NCR-Fwd may share the sensing results to the NCR-MT, and the NCR-MT may determine the measurement result based on the sensing results. The NCR-MT may further transmit the measurement result to the network device 110. In some embodiments, the NCR-MT may report the measurement result on a configured semi-static resource.

In some examples, the measurement result may include N1 carriers with top N1 RSRPs and/or RSSIs. For example, all the RSRPs and/or RSSIs in the sensing results may be ordered to determine the top N1 RSRPs and/or RSSIs, where the top N1 RSRPs and/or RSSIs are larger than the rest ones. Accordingly, the N1 carriers, among the multiple predefined carriers, associated with the top N1 RSRPs and/or RSSIs may be determined. It is noted that N1 is a preconfigured or predefined integer.

In some examples, the measurement result may indicate N2 recommended carriers among the multiple predefined carriers. For example, the measurement result may include indexes of the N2 recommended carriers. It is noted that N2 is a preconfigured or predefined integer.

In some examples, the measurement result may indicate N3 precluded carriers among the multiple predefined carriers. For example, the measurement result may include indexes of the N3 recommended carriers. It is noted that N3 is a preconfigured or predefined integer.

In some embodiments, the NCR-MT may determine the measurement result based on the signals received by the NCR-MT. In some examples, the NCR-MT may measure the interference based on the received signals to obtain the measurement result. In some examples, only DL interference may be measured. In some examples, the NCR-MT may measure RSRPs and/or RSSIs based on the received signals on multiple predefined carriers. In some examples, the NCR-MT may determine the measurement result based on RS configurations on multiple predefined carriers, for example, the multiple predefined carriers may indicate the supported forwarding carrier for NCR-Fwd, that is all the carriers for NCR-Fwd.

As such, the NCR 120 may provide a measurement result on multiple predefined carriers to the network device 110, and the network device 110 may determine a more accurate forwarding carrier based thereon. Thus, the indication may be more accurate and the communication efficiency may be improved.

In some example embodiments, the NCR 120 may turn off some or all of the supported carriers for power saving. In some embodiments, the network device 110 may transmit a notification indicating that the network device 110 is to enter into an energy saving mode. In some examples, the notification may include an indication of a time period during which the network device 110 is in the energy saving mode.

In some examples, the NCR 120 may turn off all carriers supported by the NCR-Fwd during the time period. In some examples, the NCR 120 may only turn on a minimum carrier of all carriers supported by the NCR-Fwd during the time period.

As such, the NCR 120 may consume less power when the network device 110 is in the energy saving mode, and thus a power saving at the NCR 120 may be achieved.

Reference is now made to FIG. 5A, which illustrates an example consecutive carrier for NCR-Fwd. As illustrated in FIG. 5A, the supported forwarding carrier may be within an operating band, and the operating band is from 26500 MHz to 29500 MHz (n257). In some examples, the supported forwarding carrier 510 may be from a starting point A to an ending point B.

Reference is now made to FIG. 5B, which illustrates an example non-consecutive carrier for NCR-Fwd. As illustrated in FIG. 5B, the supported forwarding carrier may be within an operating band (n257). In some examples, the supported forwarding carrier includes a first consecutive carrier 522 with a starting point A1 and an ending point B1, and a second consecutive carrier 524 with a starting point A2 and an ending point B2. There is a gap between the first consecutive carrier 522 and the second consecutive carrier 524.

Reference is now made to FIG. 5C, which illustrates example carriers for NCR-Fwd. As illustrated in FIG. 5C, there are N carriers each with a same bandwidth B0. Carrier 1 has a central frequency F1, thus the starting point of carrier 1 is F1-B0/2 and the ending point of carrier 1 is F1+B0/2. Similarly, carrier 2 has a central frequency F2, thus the starting point of carrier 2 is F2-B0/2 and the ending point of carrier 2 is F2+B0/2. Carrier N has a central frequency FN, thus the starting point of carrier N is FN-B0/2 and the ending point of carrier N is FN+B0/2.

Reference is now made to FIG. 6A, which illustrates an example relationship between the activated bandwidth for NCR-MT and the indicated forwarding bandwidth. In some examples, the indication may indicate that the activated bandwidth for NCR-MT is located at the front of the indicated forwarding bandwidth, and may further indicate that a scaling factor is 2. As shown in FIG. 6A, the activated bandwidth for NCR-MT is 50 MHz, and the forwarding bandwidth is 100 MHz (=2×50 MHz) with the activated bandwidth for NCR-MT at the front.

Reference is now made to FIG. 6B, which illustrates carrier-level ON-OFF information. As shown in FIG. 6B, the input signal may be a signal from the network device 110, and the output signals 1, 2, . . . , N may be signals forwarded to the terminal device 130. In some examples, the indication may indicate multiple on-off states corresponding to multiple carriers. The NCR 120 may turn on those carriers with on states and turn off those carriers with off states.

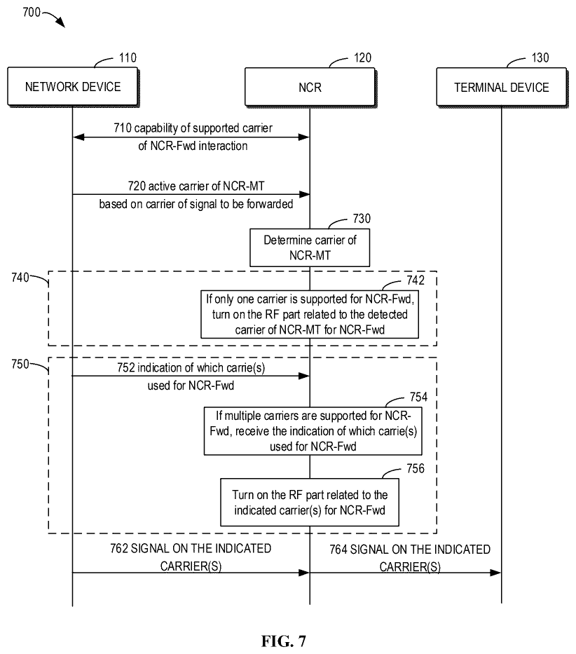

Reference is first made to FIG. 7, which illustrates a signalling chart illustrating communication process 700 in accordance with some example embodiments of the present disclosure. Only for the purpose of discussion, the process 700 will be described with reference to FIG. 1. The process 700 may involve the network device 110, the network-controlled repeater (NCR) 120, and the terminal device 130.

An interaction procedure about the capability information of supported bandwidth of NCR-Fwd may be performed 710. In some embodiments, the NCR 120 may transmit the capability information to the network device 110, through RRC signaling for example. In some embodiments, an OAM may transmit the capability information to the network device 110. The detailed embodiments on the capability information may refer to those described above with reference to FIG. 4, and will not be repeated herein.

The network device 110 may determine a carrier of NCR-MT based on a carrier of signal to be forwarded to the terminal device 130. The network device 110 may further inform the carrier of NCR-MT to the NCR 120 so as to active 720 the carrier of NCR-MT.

The NCR 120 determines 730 the carrier of NCR-MT. In some embodiments, the NCR 120 may turn on the carrier of NCR-MT. In some examples, the carrier of NCR-MT may be a detected carrier of NCR-MT.

In some example embodiments, if only one carrier is supported for NCR-Fwd, process 740 may be performed. In some example embodiments, if multiple carriers are supported for NCR-Fwd, process 750 may be performed.

In some example embodiments, the network device 110 may transmit a configuration indicating that the carrier for NCR-Fwd is the same as the carrier for NCR-MT. In some example embodiments, if only one carrier is supported for NCR-Fwd, the NCR 120 may turn on 742 the RF part related to the detected carrier of NCR-MT for NCR-Fwd. In some examples, if the carrier for NCR-Fwd is the same as the carrier for NCR-MT, or if the capability information indicates the capability type is a fixed type, the NCR 120 may turn on the corresponded carrier. As such, the carrier used by the NCR 120 (both NCR-MT and NCR-Fwd) is limited.

In some embodiments, if the capability information indicates the capability type is a dynamic type, the NCR 120 may activate the carrier for NCR-MT and the carrier is also used for NCR-Fwd. In some examples, the activation process may be implemented based on a legacy procedure according to the signal to be forwarded, and will not be described in detail herein. In some examples, a baseband processing ability (modulate is included) may be assumed at the NCR 120, as such the signal out-of-band may be discarded or muted in baseband, as described at step 764 below. In some examples, a dynamic filter in lower frequency (LF) or intermediate frequency (IF) may be assumed at the NCR 120, as such the signal out-of-band may be filtered out, as described at step 764 below.

In some embodiments, if the capability information indicates the capability type is a switch type, the activated carrier for NCR-MT may be one carrier from a set of predefined carriers. In some examples, the activated carrier for NCR-MT may be greater than a carrier used for signal transmission. In some examples, the carrier used for NCR-MT may be updated, and the carrier for NCR-Fwd is updated accordingly. In some examples, the update process of the carrier for NCR-Fwd may refer to a legacy procedure, and will not be described in detail herein.

In some example embodiments, if multiple carriers are supported for NCR-Fwd, the network device 110 transmits 752 an indication of which carrier(s) is used for NCR-Fwd. In some examples, the network device 110 may determine the carrier(s) for NCR-Fwd based on the activated carrier for NCR-MT and the capability information of NCR-Fwd. The NCR 120 receives 754 the indication if multiple carriers are supported for NCR-Fwd. The NCR 120 may turn on 756 the RF related to the indicated carrier(s) for NCR-Fwd. The detailed embodiments about the indication may refer to those described with reference to FIG. 4, thus will not be repeated herein.

The network device 110 transmits 762 the signal to the NCR 120, and the NCR 120 forwards 764 the signal to the terminal device 130.

In some example embodiments, if only one carrier is supported, the signal is transmitted on the activated carrier of NCR-MT, which is the same as the carrier of NCR-Fwd. In some example embodiments, if multiple carriers are supported, the signal is transmitted on the indicated carriers for NCR-Fwd, such as one or more of the multiple carriers.

In some examples, the original signal is filtered, so that only the signal within the activated/indicated carrier(s) can be transmitted. In some embodiments, the NCR 120 has a baseband processing ability (modulate is included at least), and the signal out-of-band may be discarded or muted. For example, the signal out-of-band is a signal on the resource or resource block or resource element different from the activated/indicated carrier(s). In some embodiments, the NCR 120 does not have the baseband processing ability, a dynamic filter in IF/LF may be performed, as such the signal out-of-band is filtered out, and the signal may be converted back to HF to be transmitted.

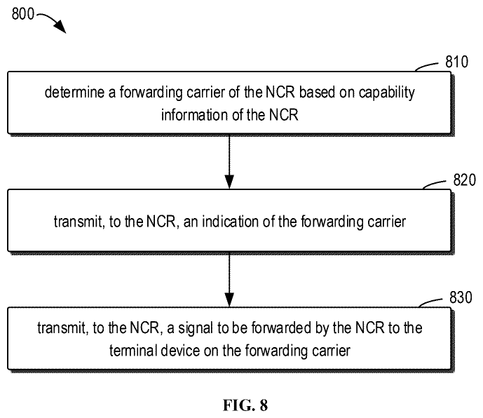

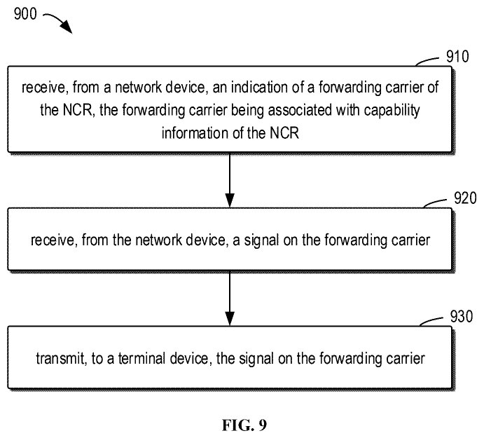

FIG. 8 illustrates a flowchart of an example method 800 implemented at a network device in accordance with some embodiments of the present disclosure. For the purpose of discussion, the method 800 will be described from the perspective of the network device 110 with reference to FIG. 1.

At block 810, the network device 110 determines a forwarding carrier of the NCR 120 based on capability information of the NCR 120. At block 82, the network device 110 transmits, to the NCR 120, an indication of the forwarding carrier. At block 830, the network device 110 transmits, to the NCR 120, a signal to be forwarded by the NCR 120 to the terminal device 130 on the forwarding carrier.

In some example embodiments, the capability information indicates that a capability type related to the forwarding carrier of the NCR 120 is a dynamic type, and further indicates one or more of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In some example embodiments, the capability information indicates that a capability type related to the forwarding carrier of the NCR 120 is a switch type, and further indicates one or more of: multiple indexes of multiple carriers in a set of pre-determined carriers, multiple bandwidths for the multiple carriers, a maximum number of carriers being used for forwarding simultaneously, or an index of a subset of carriers being used for forwarding simultaneously.

In some example embodiments, each carrier in the set of pre-determined carriers has a same bandwidth.

In some example embodiments, each of the multiple indexes is represented as a new radio-absolute radio frequency channel number (NR-ARFCN) associated with a central frequency of a corresponding carrier.

In some example embodiments, the network device 110 receives the capability information from the NCR 120 via radio resource control (RRC) signaling. In some example embodiments, the network device 110 receives the capability information from an OAM.

In some example embodiments, the network device 110 determines an activated carrier with an activated bandwidth for mobile termination (MT); and determines the forwarding carrier based on the capability information and the activated carrier for MT, the activated carrier for MT being within the forwarding carrier.

In some example embodiments, if the capability information indicates a dynamic type, the indication indicates one or more of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In some example embodiments, the central frequency is represented as an NR-ARFCN, and the list of central frequencies is represented as an NR-ARFCN list.

In some example embodiments, if the capability information indicates a switch type, the indication indicates one or more of: one or more indexes of one or more carries among multiple carriers, a first index of a subset of carriers comprising the activated carrier for MT, a second index of a subset of carriers comprising the activated carrier for MT located at the front of the subset of carriers, or a third index of a subset of carriers comprising the activated carrier for MT located at the end of the subset of carriers.

In some example embodiments, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In some example embodiments, if the capability information indicates a switch type and multiple carriers, the indication indicates multiple on-off states of the multiple carriers.

In some example embodiments, the indication is carried in a field of downlink control information (DCI), the field corresponding to a modulation and coding scheme (MCS), a transmission configuration indicator (TCI), or a frequency domain resource allocation (FDRA).

In some example embodiments, the network device 110 receives, from the NCR 120, a measurement result indicating one or more of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In some example embodiments, the network device 110 transmits, to the NCR 120, a notification indicating that the network device is to enter into an energy saving mode.

In some example embodiments, the notification comprises an indication of time period during which the network device is in the energy saving mode.

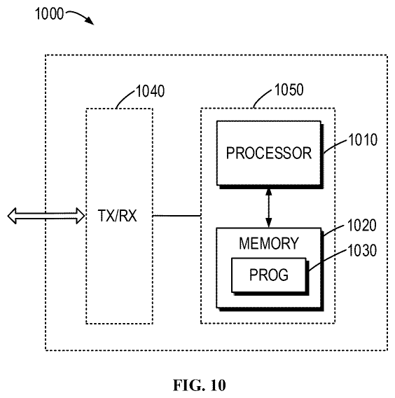

FIG. 9 illustrates a flowchart of an example method 900 implemented at an NCR in accordance with some embodiments of the present disclosure. For the purpose of discussion, the method 900 will be described from the perspective of the NCR 120 with reference to FIG. 1.

At block 910, the NCR 120 receives, from a network device 110, an indication of a forwarding carrier of the NCR 120, the forwarding carrier being associated with capability information of the NCR 120. At block 920, the NCR 120 receives, from the network device 110, a signal on the forwarding carrier At block 930, the NCR 120 transmits, to a terminal device 130, the signal on the forwarding carrier.

In some example embodiments, the NCR 120 transmits the capability information to the network device 110 via RRC signaling.

In some example embodiments, the capability information indicates that a capability type related to the forwarding carrier of the NCR 120 is a dynamic type, and further indicates one or more of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In some example embodiments, the capability information indicates that a capability type related to the forwarding carrier of the NCR 120 is a switch type, and further indicates one or more of: multiple indexes of multiple carriers in a set of pre-determined carriers, multiple bandwidths for the multiple carriers, a maximum number of carriers being used for forwarding simultaneously, or an index of a subset of carriers being used for forwarding simultaneously.

In some example embodiments, each carrier in the set of pre-determined carriers has a same bandwidth.

In some example embodiments, each of the multiple indexes is represented as an NR-ARFCN associated with a central frequency of a corresponding carrier.

In some example embodiments, the capability information indicates a dynamic type, and the indication indicates one or more of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In some example embodiments, the central frequency is represented as an NR-ARFCN, and the list of central frequencies is represented as an NR-ARFCN list.

In some example embodiments, the capability information indicates a switch type, and the indication indicates one or more of: one or more indexes of one or more carriers among multiple carriers, an index of a subset of carriers comprising the activated carrier for MT, an index of a subset of carriers comprising the activated carrier for MT located at the front of the subset of carriers, or an index of a subset of carriers comprising the activated carrier for MT located at the end of the subset of carriers.

In some example embodiments, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In some example embodiments, the capability information indicates a switch type and multiple carriers, and the indication indicates multiple on-off states of the multiple carriers.

In some example embodiments, the indication is carried in a field of downlink control information (DCI), the field corresponding to a modulation and coding scheme (MCS), a transmission configuration indicator (TCI), or a frequency domain resource allocation (FDRA).

In some example embodiments, the NCR 120 determines a measurement result based on a configured RS or a sensor related to a power of a received signal; and transmits the measurement result to the network device 110.

In some example embodiments, the measurement result indicates one or more of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In some example embodiments, the NCR 120 receives, from the network device 110, a notification indicating that the network device 110 is to enter into an energy saving mode.

In some example embodiments, the NCR 120 turns off all carriers supported by a function of NCR forwarding; or turns on a minimum carrier of the carriers supported by the function of NCR forwarding.

In some example embodiments, the notification comprises an indication of a time period during which the network device 110 is in the energy saving mode.

Details of some embodiments according to the present disclosure have been described with reference to FIGS. 1-9. Now an example implementation of the network device and the NCR will be discussed below.

In some example embodiments, a network device comprises circuitry configured to: determine a forwarding carrier of the NCR based on capability information of the NCR;

transmit, to the NCR, an indication of the forwarding carrier; and transmit, to the NCR, a signal to be forwarded by the NCR to the terminal device on the forwarding carrier.

In some example embodiments, the capability information indicates that a capability type related to the forwarding carrier of the NCR is a dynamic type, and further indicates one or more of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In some example embodiments, the capability information indicates that a capability type related to the forwarding carrier of the NCR is a switch type, and further indicates one or more of: multiple indexes of multiple carriers in a set of pre-determined carriers, multiple bandwidths for the multiple carriers, a maximum number of carriers being used for forwarding simultaneously, or an index of a subset of carriers being used for forwarding simultaneously.

In some example embodiments, each carrier in the set of pre-determined carriers has a same bandwidth.

In some example embodiments, each of the multiple indexes is represented as a new radio-absolute radio frequency channel number (NR-ARFCN) associated with a central frequency of a corresponding carrier.

In some example embodiments, the network device comprises circuitry configured to: receive the capability information from the NCR via radio resource control (RRC) signaling. In some example embodiments, the network device comprises circuitry configured to: receive the capability information from an OAM.

In some example embodiments, the network device comprises circuitry configured to: determine an activated carrier for mobile termination (MT); and determine the forwarding carrier based on the capability information and the activated carrier for MT, the activated bandwidth for MT being within the forwarding bandwidth.

In some example embodiments, if the capability information indicates a dynamic type, the indication indicates one or more of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In some example embodiments, the central frequency is represented as an NR-ARFCN, and the list of central frequencies is represented as an NR-ARFCN list.

In some example embodiments, if the capability information indicates a switch type, the indication indicates one or more of: one or more indexes of one or more carries among multiple carriers, an index of a subset of carriers comprising the activated carrier for MT, an index of a subset of carriers comprising the activated carrier for MT located at the front of the subset of carriers, or an index of a subset of carriers comprising the activated carrier for MT located at the end of the subset of carriers.

In some example embodiments, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In some example embodiments, if the capability information indicates a switch type and multiple carriers, the indication indicates multiple on-off states of the multiple carriers.

In some example embodiments, the indication is carried in a field of downlink control information (DCI), the field corresponding to a modulation and coding scheme (MCS), a transmission configuration indicator (TCI), or a frequency domain resource allocation (FDRA).

In some example embodiments, the network device comprises circuitry configured to: receive, from the NCR, a measurement result indicating one or more of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In some example embodiments, the network device comprises circuitry configured to: transmit, to the NCR, a notification indicating that the network device is to enter into an energy saving mode.

In some example embodiments, the notification comprises an indication of time period during which the network device is in the energy saving mode.

In some example embodiments, an NCR comprises circuitry configured to: receive, from a network device, an indication of a forwarding carrier of the NCR, the forwarding carrier being associated with capability information of the NCR; receive, from the network device, a signal on the forwarding carrier; and transmit, to a terminal device, the signal on the forwarding carrier.

In some example embodiments, the NCR comprises circuitry configured to: transmit the capability information to the network device via RRC signaling.

In some example embodiments, the capability information indicates that a capability type related to the forwarding carrier of the NCR is a dynamic type, and further indicates one or more of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In some example embodiments, the capability information indicates that a capability type related to the forwarding carrier of the NCR is a switch type, and further indicates one or more of: multiple indexes of multiple carriers in a set of pre-determined carriers, multiple bandwidths for the multiple carriers, a maximum number of carriers being used for forwarding simultaneously, or an index of a subset of carriers being used for forwarding simultaneously.

In some example embodiments, each carrier in the set of pre-determined carriers has a same bandwidth.

In some example embodiments, each of the multiple indexes is represented as an NR-ARFCN associated with a central frequency of a corresponding carrier.

In some example embodiments, the capability information indicates a dynamic type, and the indication indicates one or more of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In some example embodiments, the central frequency is represented as an NR-ARFCN, and the list of central frequencies is represented as an NR-ARFCN list.

In some example embodiments, the capability information indicates a switch type, and the indication indicates one or more of: one or more indexes of one or more carriers among multiple carriers, an index of a subset of carriers comprising the activated carrier for MT, an index of a subset of carriers comprising the activated carrier for MT located at the front of the subset of carriers, or an index of a subset of carriers comprising the activated carrier for MT located at the end of the subset of carriers.

In some example embodiments, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In some example embodiments, the capability information indicates a switch type and multiple carriers, and the indication indicates multiple on-off states of the multiple carriers.

In some example embodiments, the indication is carried in a field of downlink control information (DCI), the field corresponding to a modulation and coding scheme (MCS), a transmission configuration indicator (TCI), or a frequency domain resource allocation (FDRA).

In some example embodiments, the NCR comprises circuitry configured to: determine a measurement result based on a configured RS or a sensor related to a power of a received signal; and transmit the measurement result to the network device.

In some example embodiments, the measurement result indicates one or more of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In some example embodiments, the NCR comprises circuitry configured to: receive, from the network device, a notification indicating that the network device is to enter into an energy saving mode.

In some example embodiments, the NCR comprises circuitry configured to: turn off all carriers supported by a function of NCR forwarding; or turn on a minimum carrier of the carriers supported by the function of NCR forwarding.

In some example embodiments, the notification comprises an indication of a time period during which the network device is in the energy saving mode.

FIG. 10 illustrates a simplified block diagram of a device 1000 that is suitable for implementing embodiments of the present disclosure. The device 1000 can be considered as a further example implementation of the network device 110 and/or the NCR 120 as shown in FIG. 1. Accordingly, the device 1000 can be implemented at or as at least a part of the network device 110 or the NCR 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this disclosure may have several ones.

The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 4-9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In summary, embodiments of the present disclosure may provide the following solutions.

The present disclosure provides a method of communication, comprises: determining, at a network device, a forwarding carrier of a network controlled repeater (NCR) based on capability information of the NCR; transmitting, to the NCR, an indication of the forwarding carrier; and transmitting, to the NCR, a signal to be forwarded by the NCR to a terminal device on the forwarding carrier.

In one embodiment, the method as above, the capability information indicates that a capability type related to the forwarding carrier of the NCR is a dynamic type, and further indicates at least one of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In one embodiment, the method as above, the capability information indicates that a capability type related to the forwarding carrier of the NCR is a switch type, and further indicates at least one of: a plurality of indexes of a plurality of carriers in a set of pre-determined carriers, a plurality of bandwidths for the plurality of carriers, a maximum number of carriers being used for forwarding simultaneously, or an index of a subset of carriers being used for forwarding simultaneously.

In one embodiment, the method as above, each carrier in the set of pre-determined carriers has a same bandwidth.

In one embodiment, the method as above, each of the plurality of indexes is represented as a new radio-absolute radio frequency channel number (NR-ARFCN) associated with a central frequency of a corresponding carrier.

In one embodiment, the method as above, further comprising: receiving the capability information from the NCR via radio resource control (RRC) signaling; or receiving the capability information from an operation administration and maintenance (OAM).

In one embodiment, the method as above, determining the forwarding carrier comprises: determining an activated carrier with an activated bandwidth for mobile termination (MT); and determining the forwarding carrier based on the capability information and the activated carrier for MT, the activated bandwidth for MT being within the forwarding bandwidth.

In one embodiment, the method as above, in accordance with a determination that the capability information indicates a dynamic type, the indication indicates at least one of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In one embodiment, the method as above, the central frequency is represented as an NR-ARFCN, and the list of central frequencies is represented as an NR-ARFCN list.

In one embodiment, the method as above, in accordance with a determination that the capability information indicates a switch type, the indication indicates at least one of: one or more indexes of one or more carries among a plurality of carriers, a first index of a subset of carriers comprising the activated carrier for MT, a second index of a subset of carriers comprising the activated carrier for MT located at the front of the subset of carriers, or a third index of a subset of carriers comprising the activated carrier for MT located at the end of the subset of carriers.

In one embodiment, the method as above, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In one embodiment, the method as above, in accordance with a determination that the capability information indicates a switch type and a plurality of carriers, the indication indicates a plurality of on-off states of the plurality of carriers.

In one embodiment, the method as above, the indication is carried in a field of downlink control information (DCI), the field corresponding to a modulation and coding scheme (MCS), a transmission configuration indicator (TCI), or a frequency domain resource allocation (FDRA).

In one embodiment, the method as above, further comprising: receiving, from the NCR, a measurement result indicating at least one of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In one embodiment, the method as above, further comprising: transmitting, to the NCR, a notification indicating that the network device is to enter into an energy saving mode.

In one embodiment, the method as above, the notification comprises an indication of time period during which the network device is in the energy saving mode.

The present disclosure provides a method of communication, comprises: receiving, at a network controlled repeater (NCR) from a network device, an indication of a forwarding carrier of the NCR, the forwarding carrier being associated with capability information of the NCR; receiving, from the network device, a signal on the forwarding carrier; and transmitting, to a terminal device, the signal on the forwarding carrier.

In one embodiment, the method as above, further comprising: transmitting the capability information to the network device via radio resource control (RRC) signaling.

In one embodiment, the method as above, the capability information indicates that a capability type related to the forwarding carrier of the NCR is a dynamic type, and further indicates at least one of: a number of carriers, a carrier with a starting point and an ending point, whether the starting point is adjustable, whether the ending point is adjustable, a step for adjusting the starting point, a step for adjusting the ending point, a minimum value of adjusted bandwidth, or a maximum value of the adjusted bandwidth.

In one embodiment, the method as above, the capability information indicates that a capability type related to the forwarding carrier of the NCR is a switch type, and further indicates at least one of: a plurality of indexes of a plurality of carriers in a set of pre-determined carriers, a plurality of bandwidths for the plurality of carriers, a maximum number of carriers being used for forwarding simultaneously, or an index of a subset of carriers being used for forwarding simultaneously.

In one embodiment, the method as above, each carrier in the set of pre-determined carriers has a same bandwidth.

In one embodiment, the method as above, each of the plurality of indexes is represented as a new radio-absolute radio frequency channel number (NR-ARFCN) associated with a central frequency of a corresponding carrier.

In one embodiment, the method as above, the capability information indicates a dynamic type, and the indication indicates at least one of: a central frequency and a bandwidth, a list of central frequencies and a list of bandwidths, a list of central frequencies and a common bandwidth, a location of the activated carrier for MT within the forwarding carrier, or a scaling factor indicating a multiple of the forwarding bandwidth relative to the activated bandwidth for MT.

In one embodiment, the method as above, the central frequency is represented as an NR-ARFCN, and the list of central frequencies is represented as an NR-ARFCN list.

In one embodiment, the method as above, the capability information indicates a switch type, and the indication indicates at least one of: one or more indexes of one or more carriers among a plurality of carriers, a first index of a subset of carriers comprising the activated carrier for MT, a second index of a subset of carriers comprising the activated carrier for MT located at the front of the subset of carriers, or a third index of a subset of carriers comprising the activated carrier for MT located at the end of the subset of carriers.

In one embodiment, the method as above, the index of a subset of carriers is renumbered based on: an order of determined subsets of carriers comprising the activated carrier for MT, an order of determined subsets of carriers comprising the activated carrier for MT located at the front of each of the subsets of carriers, or an order of determined subsets of carriers comprising the activated carrier for MT located at the end of each of the subsets of carriers.

In one embodiment, the method as above, the capability information indicates a switch type and a plurality of carriers, and the indication indicates a plurality of on-off states of the plurality of carriers.

In one embodiment, the method as above, the indication is carried in a field of downlink control information (DCI), the field corresponding to a modulation and coding scheme (MCS), a transmission configuration indicator (TCI), or a frequency domain resource allocation (FDRA).

In one embodiment, the method as above, further comprising: determining a measurement result based on a configured reference signal (RS) or a sensor related to a power of a received signal; and transmitting the measurement result to the network device.

In one embodiment, the method as above, the measurement result indicates at least one of: a power of a received signal for a predefined carrier, a strength indicator of the received signal for the predefined carrier, a number of received powers of received signals for a predetermined number of carriers, a number of strength indicators of the received signals for the predefined number of carriers, an index of a recommended carrier, or an index of a precluded carrier.

In one embodiment, the method as above, further comprising: receiving, from the network device, a notification indicating that the network device is to enter into an energy saving mode.

In one embodiment, the method as above, further comprising: turning off all carriers supported by a function of NCR forwarding; or turning on a minimum carrier of the carriers supported by the function of NCR forwarding.

In one embodiment, the method as above, the notification comprises an indication of a time period during which the network device is in the energy saving mode.

The present disclosure provides a network device, comprising: a processor; and a memory storing computer program codes; the memory and the computer program codes configured to, with the processor, cause the network device to perform the method implemented at the network device discussed above.

The present disclosure provides a network-controlled repeater, comprising: a processor; and a memory storing computer program codes; the memory and the computer program codes configured to, with the processor, cause the network-controlled repeater to perform the method implemented at the network-controlled repeater discussed above.

The present disclosure provides a computer readable medium having instructions stored thereon, the instructions, when executed by a processor of an apparatus, causing the apparatus to perform the method implemented at a network device or a network-controlled repeater discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a network device, a forwarding carrier of a network controlled repeater (NCR) based on capability information of the NCR;
transmitting, to the NCR, an indication of the forwarding carrier; and
transmitting, to the NCR, a signal to be forwarded by the NCR to a terminal device on the forwarding carrier.

2. The method of claim 1, wherein the capability information indicates that a capability type related to the forwarding carrier of the NCR is a dynamic type, and further indicates at least one of:
a number of carriers,
a carrier with a starting point and an ending point,
whether the starting point is adjustable,
whether the ending point is adjustable,
a step for adjusting the starting point,
a step for adjusting the ending point,
a minimum value of adjusted bandwidth, or
a maximum value of the adjusted bandwidth.

3. The method of claim 1, wherein the capability information indicates that a capability type related to the forwarding carrier of the NCR is a switch type, and further indicates at least one of:
a plurality of indexes of a plurality of carriers in a set of pre-determined carriers,
a plurality of bandwidths for the plurality of carriers,
a maximum number of carriers being used for forwarding simultaneously, or
an index of a subset of carriers being used for forwarding simultaneously.

4. The method of claim 1, wherein determining the forwarding carrier comprises:
determining an activated carrier with an activated bandwidth for mobile termination (MT); and
determining the forwarding carrier based on the capability information and the activated carrier for MT, the activated carrier for MT being within the forwarding carrier.

5. The method of claim 4, wherein in accordance with a determination that the capability information indicates a dynamic type, the indication indicates at least one of:
a central frequency and a bandwidth,
a list of central frequencies and a list of bandwidths,
a list of central frequencies and a common bandwidth,
a location of the activated carrier for MT within the forwarding carrier, or
a scaling factor indicating a multiple of a forwarding bandwidth of the forwarding carrier relative to the activated bandwidth for MT.

6. The method of claim 4, wherein in accordance with a determination that the capability information indicates a switch type, the indication indicates at least one of:
one or more indexes of one or more carries among a plurality of carriers,
a first index of a subset of carriers comprising the activated carrier for MT,
a second index of a subset of carriers comprising the activated carrier for MT located at the front of the subset of carriers, or
a third index of a subset of carriers comprising the activated carrier for MT located at the end of the subset of carriers.

7. The method of claim 1, wherein the indication is carried in a field of downlink control information (DCI), the field corresponding to a modulation and coding scheme (MCS), a transmission configuration indicator (TCI), or a frequency domain resource allocation (FDRA).

8. The method of claim 1, further comprising:
transmitting, to the NCR, a notification indicating that the network device is to enter into an energy saving mode.

9. A method of communication, comprising:
receiving, at a network controlled repeater (NCR) from a network device, an indication of a forwarding carrier of the NCR, the forwarding carrier being associated with capability information of the NCR;
receiving, from the network device, a signal on the forwarding carrier; and
transmitting, to a terminal device, the signal on the forwarding carrier.

10. The method of claim 9, wherein the capability information indicates that a capability type related to the forwarding carrier of the NCR is a dynamic type, and further indicates at least one of:
a number of carriers,
a carrier with a starting point and an ending point,
whether the starting point is adjustable,
whether the ending point is adjustable,
a step for adjusting the starting point,
a step for adjusting the ending point,
a minimum value of adjusted bandwidth, or
a maximum value of the adjusted bandwidth.

11. The method of claim 9, wherein the capability information indicates that a capability type related to the forwarding carrier of the NCR is a switch type, and further indicates at least one of:
a plurality of indexes of a plurality of carriers in a set of pre-determined carriers,
a plurality of bandwidths for the plurality of carriers,
a maximum number of carriers being used for forwarding simultaneously, or
an index of a subset of carriers being used for forwarding simultaneously.

12. The method of claim 9, wherein the capability information indicates a dynamic type, and the indication indicates at least one of:
a central frequency and a bandwidth,
a list of central frequencies and a list of bandwidths,
a list of central frequencies and a common bandwidth,
a location of an activated carrier for MT within the forwarding carrier, or
a scaling factor indicating a multiple of a forwarding bandwidth of the forwarding carrier relative to an activated bandwidth of the activated carrier for MT.

13. The method of claim 9, wherein the capability information indicates a switch type, and the indication indicates at least one of:
one or more indexes of one or more carriers among a plurality of carriers,
a first index of a subset of carriers comprising the activated carrier for MT,
a second index of a subset of carriers comprising the activated carrier for MT located at the front of the subset of carriers, or
a third index of a subset of carriers comprising the activated carrier for MT located at the end of the subset of carriers.

14. The method of claim 9, wherein the indication is carried in a field of downlink control information (DCI), the field corresponding to a modulation and coding scheme (MCS), a transmission configuration indicator (TCI), or a frequency domain resource allocation (FDRA).

15. The method of claim 9, further comprising:
receiving, from the network device, a notification indicating that the network device is to enter into an energy saving mode.

16. The method of claim 15, further comprising:
turning off all carriers supported by a function of NCR forwarding; or
turning on a minimum carrier of the carriers supported by the function of NCR forwarding.

17. A network device comprising:
a processor; and
a memory storing computer program codes;
the memory and the computer program codes configured to, with the processor, cause the network device to:
determine a forwarding carrier of a network controlled repeater (NCR) based on capability information of the NCR;
transmit, to the NCR, an indication of the forwarding carrier; and
transmit, to the NCR, a signal to be forwarded by the NCR to a terminal device on the forwarding carrier.

18-19. (canceled)

20. The network device of claim 17, wherein the capability information indicates that a capability type related to the forwarding carrier of the NCR is a dynamic type, and further indicates at least one of:
a number of carriers,
a carrier with a starting point and an ending point,
whether the starting point is adjustable,
whether the ending point is adjustable,
a step for adjusting the starting point,
a step for adjusting the ending point,
a minimum value of adjusted bandwidth, or
a maximum value of the adjusted bandwidth.

21. The network device of claim 17, wherein the capability information indicates that a capability type related to the forwarding carrier of the NCR is a switch type, and further indicates at least one of:
a plurality of indexes of a plurality of carriers in a set of pre-determined carriers,
a plurality of bandwidths for the plurality of carriers,
a maximum number of carriers being used for forwarding simultaneously, or
an index of a subset of carriers being used for forwarding simultaneously.

22. The network device of claim 17, wherein the at least one processor is configured to cause the network device to:
determine an activated carrier with an activated bandwidth for mobile termination (MT); and
determine the forwarding carrier based on the capability information and the activated carrier for MT, the activated carrier for MT being within the forwarding carrier.
